(19) United States
(12) Patent Application Publication
(10) Pub. No.: US 2019/0139066 A1
(43) Pub. Date: May 9, 2019

(54) CUSTOMIZED CART MANAGEMENT SYSTEM

(71) Applicant: Walmart Apollo, LLC, Bentonville, AR (US)

(72) Inventors: Greg Bryan, Bentonville, AR (US); David Blair Brightwell, Bentonville, AR (US); Cristy Crane Brooks, Cassville, AR (US); Benjamin D. Enssle, Bella Vista, AR (US); Jesse Lee Eaton, Springdale, AR (US); Jeffrey Kerbs, Bella Vista, AR (US)

(21) Appl. No.: 16/165,412

(22) Filed: Oct. 19, 2018

Related U.S. Application Data
(60) Provisional application No. 62/583,729, filed on Nov. 9, 2017.

(51) Int. Cl. G06Q 30/02; H04W 4/021; H04W 4/029

(52) U.S. Cl. CPC G06Q 30/0207; H04W 4/029; H04W 4/021

(57) ABSTRACT

Examples provide a customized cart management system. A cart monitoring component monitors a location of one or more unattended carts outside a cart intake area. A cart intake component generates cart intake data for each cart returned to the cart intake area, including a cart identifier and a cart return time. A verification component analyzes the cart intake data using a set of reward criteria, including a minimum cart return time threshold, to determine if the user is eligible to receive a cart reward. If the user is eligible, an incentives generation component assigns a first reward to the identified user. A feedback query component outputs a feedback query associated with the one or more returned carts to a user device. If the user provides feedback in response to the feedback query, the incentives generation component assigns a second reward to the user.

### BACKGROUND

After a customer at a retail store completes a shopping transaction, the customer frequently leaves their shopping cart in an exterior cart corral in a parking area outside the retail store. Typically, one or more employees of the retail store manually collects the shopping carts from the parking lot area and returns them to a cart dispensing area inside the retail store for access by newly arriving customers. This is a time consuming, tedious, and labor-intensive process. Moreover, employees may fail to locate shopping carts which have been abandoned outside a cart corral. This may lead to a shortage of available shopping carts for customer utilization, loss of sales, and negative customer experience.

### SUMMARY

Examples of the disclosure provide a system for a customized cart management. The system includes a memory and one or more processor(s) communicatively coupled to the memory. A cart intake component, implemented on the processor(s), identifies a cart returned to a designated cart intake area by an identified user. The returned cart is identified based on an analysis of sensor data generated. The sensor data is generated by one or more sensor device(s) associated with the designated cart intake area. The cart intake component generates cart intake data associated with the identified cart. The cart intake data includes a cart identifier, a cart removal time, and a cart return time. A verification component is also implemented on the processor(s). The verification component analyzes the cart intake data using a minimum return time threshold to determine whether the identified user is eligible to receive a cart return reward. An incentives generation component, implemented on the processor(s), outputs the cart return reward to the identified user for returning the identified cart to the cart intake area if an amount of time between the cart removal time and the cart return time exceeds the minimum return time threshold. A notification component is implemented on the processor(s). The notification component outputs a rewards denial notification to a computing device associated with the identified user if the minimum return time threshold exceeds the amount of time between the cart removal time and the cart return time for the identified cart.

Other examples of the disclosure provide a computer-implemented method for customized cart management. A cart monitoring component identifies a user device associated with a user within a predetermined zone. The cart monitoring component outputs a location of each cart in a set of unattended carts within the predetermined zone outside a designated cart intake area to the user device associated with the user. An unattended cart is a cart remaining in a stationary position outside the designated cart intake area for a threshold idle time. A cart intake component analyzes sensor data generated by at least one sensor device associated with the designated intake area. The cart intake component identifies one or more carts returned to the designated cart intake area by the user based on the analysis of the sensor data. An incentives generation component assigns a first reward to the identified user for each returned cart corresponding to a the one or more carts in the set of unattended carts. A feedback query component outputs a feedback query associated with at least one cart in the one or more returned carts to the identified user via the user device. A feedback reward component assigns a second reward to the identified user on condition of receiving feedback in response to the feedback query.

Still other examples of the disclosure provide one or more computer storage media, having computer-executable instructions for customized cart management. The computer-executable instructions are executed by a computer to cause the computer to analyze sensor data received from at least one sensor associated with a cart intake area. The sensor data is analyzed to identify a cart returned to the cart intake area by at least one user. The computer-executable instructions are further executed to cause the computer to generate cart intake data associated with the identified cart. The cart intake data includes a cart identifier and a first cart return time. The computer-executable instructions are further executed to cause the computer to verify the at least one user as an identified user eligible to receive a cart return reward based on the first cart return time and a second cart return time. The second cart return time includes a time associated with a previous return of the identified cart to the cart intake area. The computer-executable instructions are further executed to cause the computer to assign a cart return reward to the identified user for returning the identified cart to the cart intake area if an amount of time between the first cart return time and the second cart return time for the identified cart exceeds a minimum cart return threshold time.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a computing device for customized cart returns.

FIG. 2 is an exemplary block diagram illustrating a cart intake area.

FIG. 3. is an exemplary block diagram illustrating a predetermined cart monitoring zone.

FIG. 4 is an exemplary block diagram illustrating of cart management component.

FIG. 5 is an exemplary block diagram illustrating a feedback component.

FIG. 6 is an exemplary block diagram illustrating a database storing cart management data.

FIG. 7 is an exemplary flow chart illustrating operation of the computing device to provide a cart reward based on a threshold minimum cart return time.

FIG. 8 is an exemplary flow chart illustrating operation of the computing device to assign rewards to a user based on carts returned by the user and cart feedback received from the user.

FIG. 9 is an exemplary flow chart illustrating operation of the computing device to output a cart reward based on a number of cart returns.

FIG. 10 is an exemplary flow chart illustrating operation of the computing device to output rewards to a user for returning unattended carts in a predetermined zone.

FIG. 11 is an exemplary flow chart illustrating operation of the computing device to identify unattended carts.

FIG. 12 is an exemplary flow chart illustrating operation of the computing device to manage cart feedback received from a user.

Corresponding reference characters indicate corresponding parts throughout the drawings.

### DETAILED DESCRIPTION

Referring to the figures, examples of the disclosure enable customized cart management. In some examples, a cart management component provides rewards to users for returning abandoned shopping carts to a cart intake area if an amount of time between cart returns exceeds a minimum cart return threshold time. If a user attempts to remove a cart and immediately return the same cart for a reward, the reward is denied. This enables efficient, crowd-sourced returns of shopping carts to the cart intake area while preventing abuse of the rewards system.

A cart monitoring component, in other examples, identifies a user and/or identifies a user device arriving/entering a predetermined zone outside a cart intake area. If any unattended carts are within the predetermined zone, the cart monitoring component sends a location of each unattended cart to the identified user or user device associated with the identified user. If the user returns one or more of the unattended carts to the cart intake area, the user is provided with one or more cart return rewards. This incentivizes arriving customers to collect abandoned shopping carts in the parking area near the customer's vehicle and bring those abandoned shopping carts back into the store as they are entering the store. The monitoring component enables quick and efficient identification of carts and cart locations available for return and encourages user participation in the cart return rewards program.

In other examples, a feedback component obtains cart feedback from users returning carts to the cart intake area. If the feedback indicates repair or maintenance of a given cart may be indicated, the feedback component notifies a manager to move the given cart to a maintenance area and/or otherwise assign the cart to maintenance/repair. The feedback component enables improved accuracy and efficiency in identifying carts for maintenance and/or repair.

The cart management system in some examples provides incentives for customers to not only return the shopping cart used for a shopping trip, but to return other shopping carts left in exterior cart corrals or abandoned in parking areas or green spaces outside a retail store. The cart rewards provide gamification of the cart returns to encourage return of carts while entertaining and/or rewarding customers returning the carts.

The cart rewards in other examples provide cost savings by reducing the number of carts to be retrieved from parking areas by cart management personnel. This enables more associates to be present on the sales floor. It also reduces cart management time and expense while improving cart availability for customers.

The cart rewards also encouraging customers to return their own carts and other unattended carts to the cart intake areas to further reduce parking area congestion, decrease automobile-cart collisions, and improve availability of parking spaces due fewer abandoned carts blocking parking spaces.

In other examples, the cart management system reduces the number of cart corrals needed in exterior areas, such as parking lots. This decreases costs associated with erecting and maintaining cart corrals, frees additional parking space, and improves the exterior appearance of retail stores.

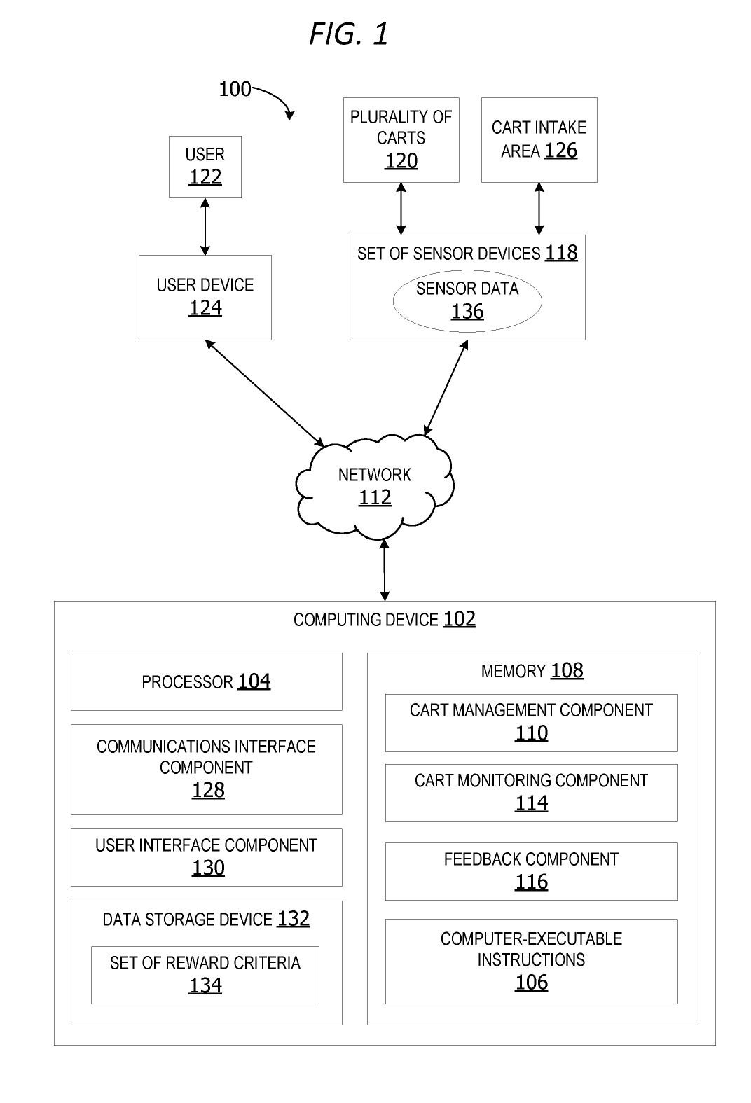

Referring again to FIG. 1, an exemplary block diagram illustrates a customized cart return system 100. In the example of FIG. 1, the computing device 102 represents any device executing instructions (e.g., as application programs, operating system functionality, or both) to implement the operations and functionality associated with the computing device 102. The computing device 102 may include a mobile computing device or any other portable device. In some examples, the mobile computing device includes a mobile telephone, laptop, tablet, computing pad, netbook, gaming device, and/or portable media player. The computing device 102 may also include less portable devices such as desktop personal computers, kiosks, tabletop devices, industrial control devices, wireless charging stations, and electric automobile charging stations. Additionally, the computing device 102 may represent a group of processing units or other computing devices.

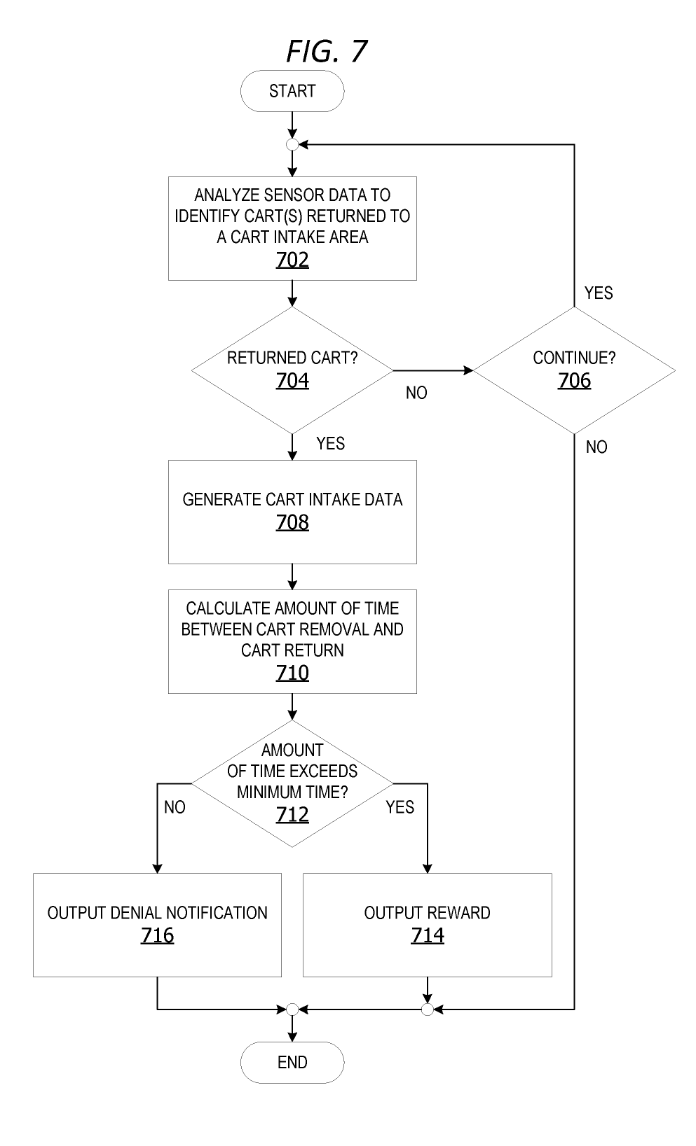

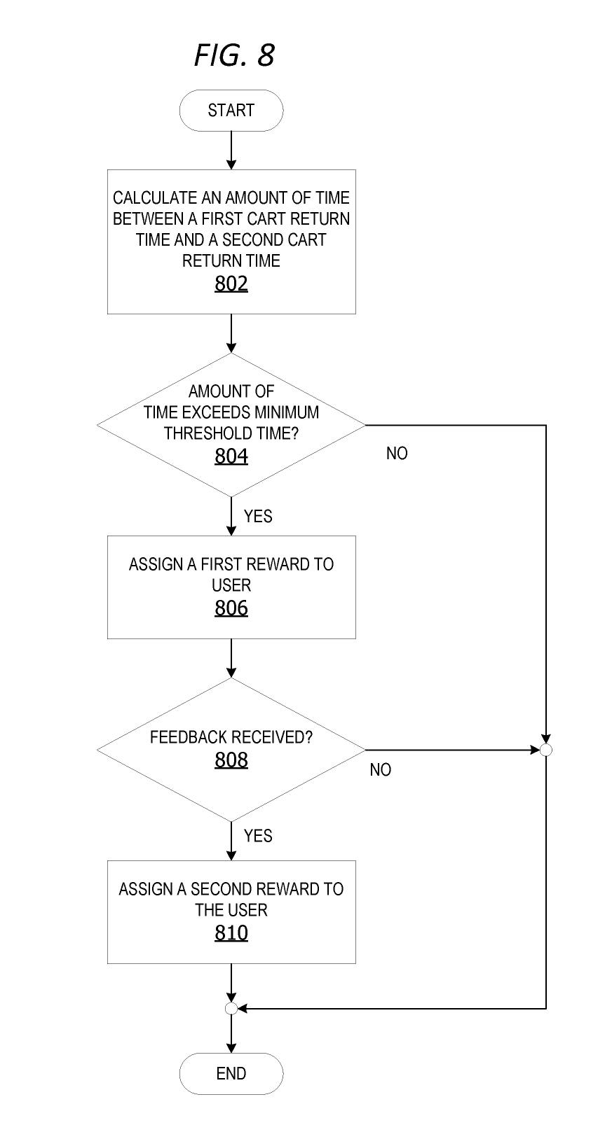

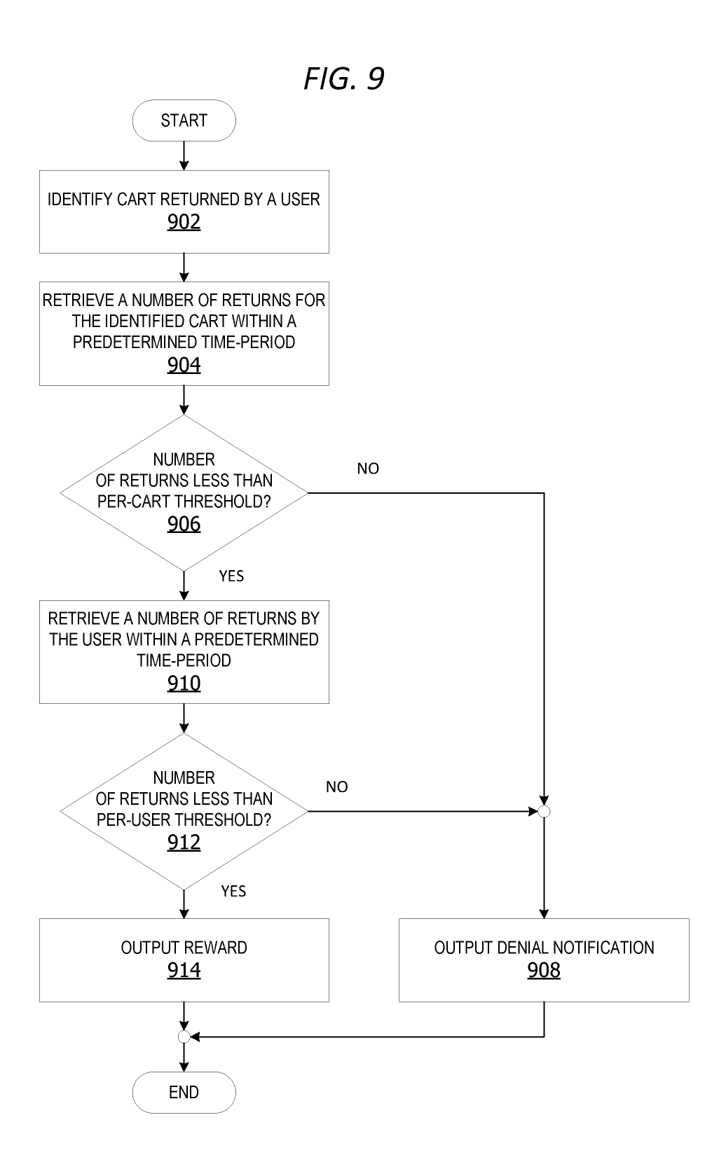

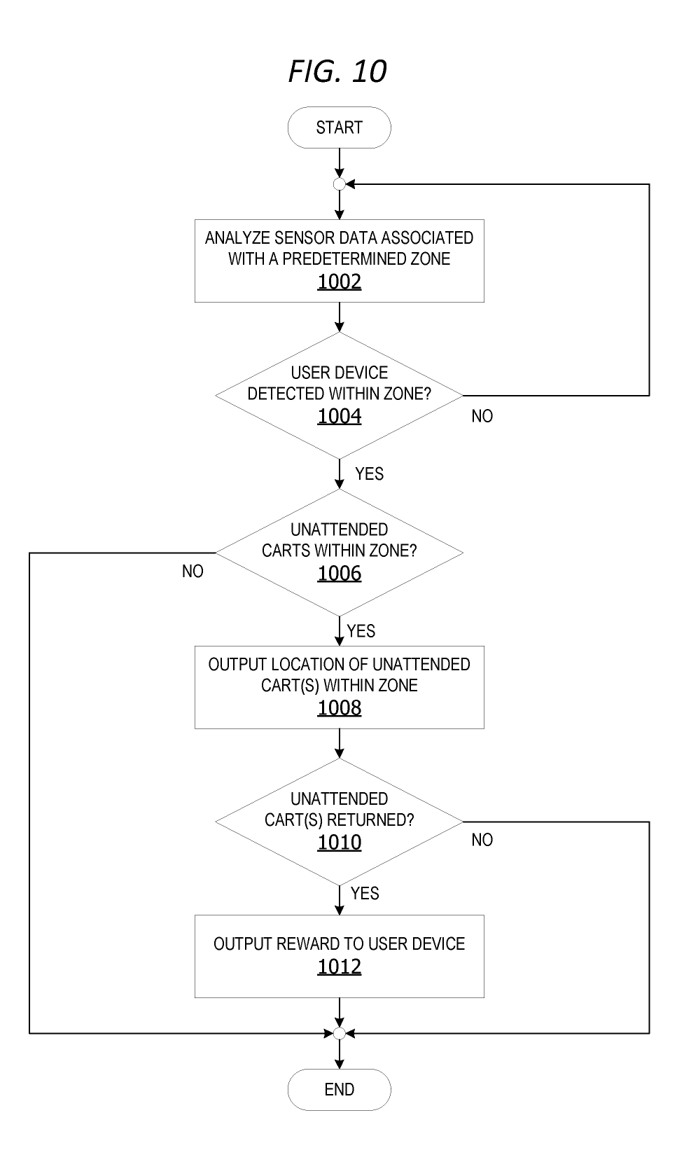

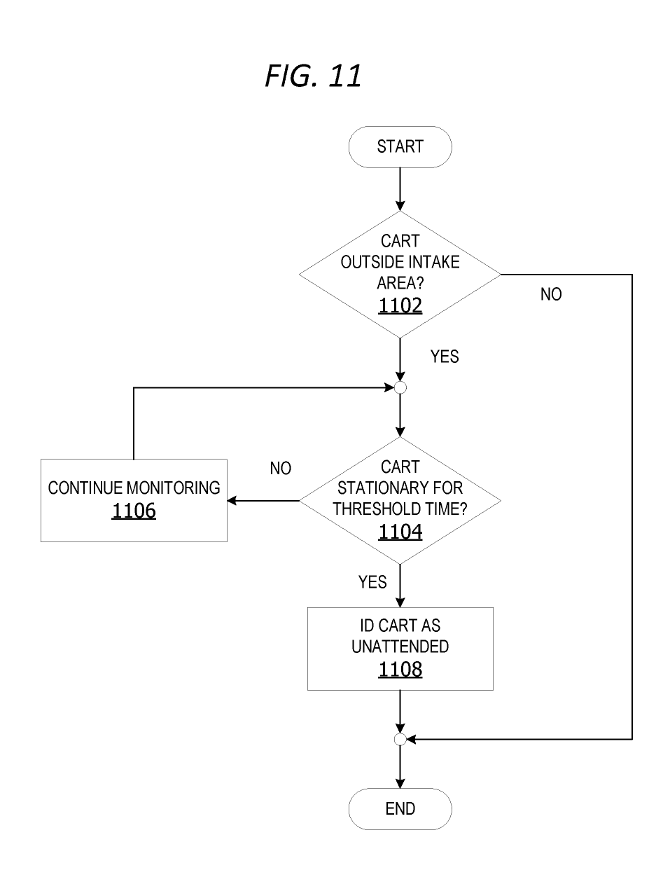

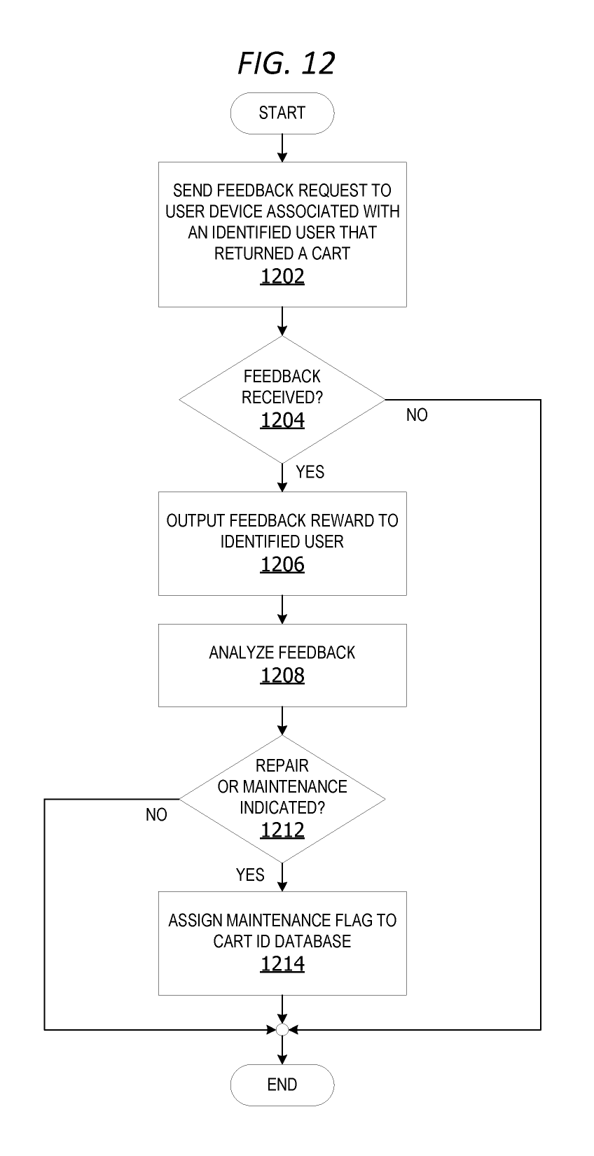

In some examples, the computing device 102 has at least one processor 104 and a memory 108. The processor 104 includes any quantity of processing units, and is programmed to execute computer-executable instructions 106. The computer-executable instructions 106 may be performed by the processor 104 or by multiple processors within the computing device 102, or performed by a processor external to the computing device 102. In some examples, the processor 104 is programmed to execute instructions such as those illustrated in the figures (e.g., FIG. 7, FIG. 8, FIG. 9, FIG. 10, FIG. 11, and FIG. 12).

In some examples, the processor 104 represents an implementation of analog techniques to perform the operations described herein. For example, the operations may be performed by an analog computing device and/or a digital computing device.

The computing device 102 further has one or more computer readable media, such as the memory 108. The memory 108 includes any quantity of media associated with or accessible by the computing device 102. The memory 108 may be internal to the computing device 102 (as shown in FIG. 1), external to the computing device (not shown), or both (not shown). In some examples, the memory 108 includes read-only memory and/or memory wired into an analog computing device.

The memory 108 stores data, such as one or more applications. The applications, when executed by the processor 104, operate to perform functionality on the computing device 102. The applications may communicate with counterpart applications or services, such as web services accessible via a network 112. For example, the applications may represent downloaded client-side applications that correspond to server-side services executing in a cloud.

The network 112 is implemented by one or more physical network components, such as, but without limitation, routers, switches, network interface cards (NICs), and other network devices. The network 112 may be any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 may be a local or private LAN.

The memory further stores one or more computer-executable components. Exemplary components include a cart management component 110, a cart monitoring component 114, a feedback component 116.

The cart monitoring component 114, when executed by the processor of the computing device 102, causes the processor 104 analyze sensor data 136 generated by a set of one or more sensor devices 118 associated with a plurality of carts 120 to identify unattended carts, identify a user 122 within a predetermined zone, and/or identify a user device 124 within the predetermined zone that is associated with the user 122.

The sensor data 136 is generated by one or more sensors in the predetermined zone. The sensor data 136 may include still camera images, video data, audio data, infrared image data, radio frequency identification (RFID) tag data, beacon data, or any other type of data generated by a sensor device. The sensor data 136 in other examples may also include user login data and/or global positioning system (GPS) data.

The set of sensor devices 118 may include one or more sensor devices attached to a cart in the plurality of carts and/or one or more sensor devices attached to a fixture within the predetermined zone outside a cart intake area 126. For example, a sensor device may be mounted to a pole, light fixture, a building/other structure, fence, wall, guard rail, cart corral, embedded in a parking surface, attached to a roof, or located anywhere within the predetermined zone.

A sensor device in the set of sensor devices 118 may include an image capture device, an RFID tag reader, a beacon, a microphone, a pressure sensor, a barcode reader, or any other type of sensor device for identifying a cart in the plurality of carts 120.

The cart monitoring component 114 identifies a location of each cart in a set of unattended carts that are outside a designated cart intake area based on an analysis of the sensor data 136. In some examples, the cart monitoring component 114 outputs the location of every unattended cart to a user device associated with an identified user located within the predetermined zone. In other examples, the cart monitoring component 114 only outputs the location of each unattended cart that is within a predetermined distance from a current location of the identified user. In other words, the cart monitoring component 114 only sends the location of unattended carts that are close to the user's current location.

The output set of unattended carts includes one or more cart identifications (ID) and a location of each unattended cart. In one non-limiting example, the output set of unattended carts that includes three unattended carts sent to a user may include the following:
Unattended cart-123 located in cart corral A on aisle 12;
Unattended cart-456 located in cart corral A on aisle 12; and
Unattended cart-789 located in parking spot 2 on aisle 11.

The examples are not limited to output in this type of text-only format. A location and/or identification of unattended carts may be presented to a user in any available format. For example, the unattended carts may be identified in an audio format, a combination of audio and visual, a printout (hardcopy), or any other format. Moreover, the output may include additional information not shown above, such as, but not limited to, more detailed location data, a timestamp, a user identifier, or any other additional data.

The output set of unattended carts may be displayed to the user on a user's mobile device, such as the user device 124 or via the computing device 102. In this example, the computing device 102 may be implemented as a kiosk located within the parking lot, near an entrance to a retail store, or any other location within the predetermined zone for presenting a list of one or more unattended carts pre-qualified to receive a cart reward if the user returns the cart to the cart intake area.

In some examples, the output set of unattended carts may include a map function which displays a map of the predetermined zone with indicators pointing out the location of each unattended cart relative to the location of the user. If the user returns one of the carts identified in the output set of unattended carts as the user is entering the retail store, the user is issue a reward based on the number of carts returned.

The cart management component 110, when executed by the processor of the computing device 102 in other examples, causes the processor 104 to identify one or more carts returned to the designated cart intake area 126 by the identified user 122 based on analyzed sensor data 136 generated by at least one sensor device in the set of sensor devices 118 associated with the designated cart intake area 126. In other examples, the cart management component 110 assigns a cart reward to the identified user for each cart returned to the cart intake area.

The feedback component 116, when executed by the processor 104 of the computing device 102, causes the processor 104 to output a feedback query associated with a returned cart to the identified user 122 via the user device 124. The feedback component 116 assigns, a feedback reward to the identified user 122 on condition of receiving feedback from the identified user 122.

The cart reward and the feedback reward may be implemented as any type of incentive or benefit to the user returning cart(s) and/or providing feedback. A reward may include a coupon providing a discount on a specific item, a discount on a total purchase amount, one or more free items, and/or reward points. Reward points may include any type of point system in which the user earns and saves points which may later be redeemed for other items.

In some examples, the reward is provided for immediate utilization. For example, a reward may be, without limitation, an automatic discount on the user's next purchase of one or more items. This purchase may take place on the same day as the occurrence of the cart return and/or provision of the feedback.

In other examples, the reward is provided for utilization on a future date. For example, a reward may be points added to the user's account which may be redeemed at some future time to obtain a free or discounted item.

The reward may be a percentage discount off a single purchased item or the reward may be a percentage discount off the purchase amount of all items purchased in a next transaction.

In other examples, the reward is a fixed discount amount. For example, the reward may be a dollar credit to be used on the next purchase. The reward may be a one-dollar discount off a particular item, such as, but not limited to, one-dollar discount for a particular brand of toothpaste.

The reward in other examples may be a fixed discount amount taken off any item having a particular purchase price, such as five-dollars off any item that costs ten dollars or more. The reward may be a fixed dollar amount off a total purchase amount in a single transaction, such as five-dollars off the next purchase of twenty-five dollars or more.

The computing device 102 may optionally include a communications interface component 128. In some examples, the communications interface component 128 includes a network interface card and/or computer-executable instructions (e.g., a driver) for operating the network interface card. Communication between the computing device 102 and other devices may occur using any protocol or mechanism over any wired or wireless connection. In some examples, the communications interface component 128 is operable with short range communication technologies such as by using near-field communication (NFC) tags.

The computing device 102 may also optionally include a user interface component 130. In some examples, the user interface component 130 includes a graphics card for displaying data to the user and receiving data from the user. The user interface component 130 may also include computer-executable instructions (e.g., a driver) for operating the graphics card. Further, the user interface component 130 may include a display (e.g., a touch screen display or natural user interface) and/or computer-executable instructions (e.g., a driver) for operating the display. The user interface component 130 may also include one or more of the following to provide data to the user or receive data from the user: speakers, a sound card, a camera, a microphone, a vibration motor, one or more accelerometers, a BLUETOOTH brand communication module, global positioning system (GPS) hardware, and a photoreceptive light sensor. For example, the user may input commands or manipulate data by moving the computing device in a particular way.

A data storage device 132 may be provided for storing cart management data, such as, but not limited to, a set of reward criteria 134. The set of reward criteria 134 in this non-limiting example includes thresholds for determining whether a user is qualified to receive a reward for returning a cart and/or providing feedback. For example, the set of reward criteria 134 may include the minimum cart return time threshold.

The data storage device 132 may include a set of one or more data storage devices storing data. The data storage device 132 may include one or more types of data storage devices, such as, for example, one or more rotating disks drives, one or more solid state drives (SSDs), and/or any other type of data storage device. The data storage device in some non-limiting examples includes a redundant array of independent disks (RAID) array. In other examples, the data storage device 132 includes a database.

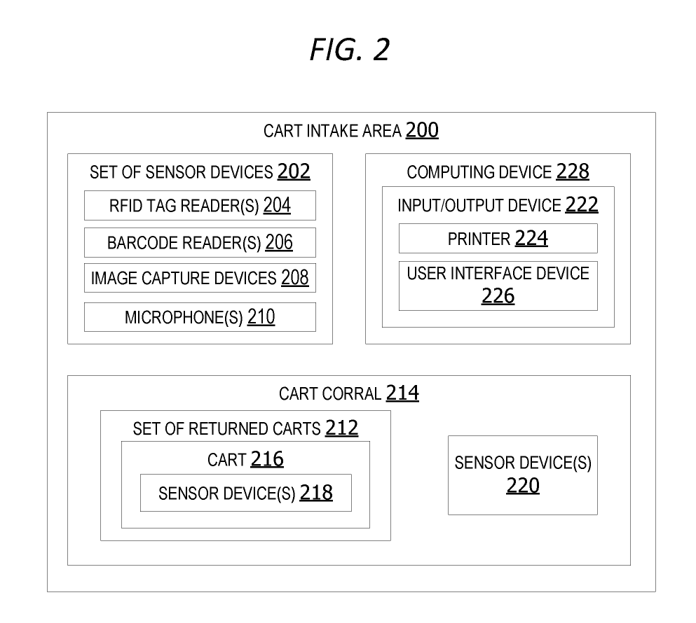

FIG. 2 is an exemplary block diagram illustrating a cart intake area 200. The cart intake area 200 is an area outside the predetermined zone in this example. The predetermined zone is an area in which the location of one or more carts are monitored. In some examples, the predetermined zone may include an interior of a retail store as well as an exterior area, such as a parking lot.

The cart intake area 200 is an area where carts may be returned. The cart intake area may include one or more cart corrals. The cart intake area 200 is outside the predetermined zone in this example because it is unnecessary to monitor or track the location of carts that are already returned to the cart intake area. When a cart is removed from the cart intake area by a user, the system resumes tracking the location of the removed cart. When a cart is returned to the cart intake area 200, the location of the cart is known, the cart is no longer is use, and/or the cart is confined within the cart intake area by a barrier, gate, wheel stop, or other device for preventing the cart from unintentionally rolling away. Therefore, monitoring carts within the cart intake area may be unnecessary.

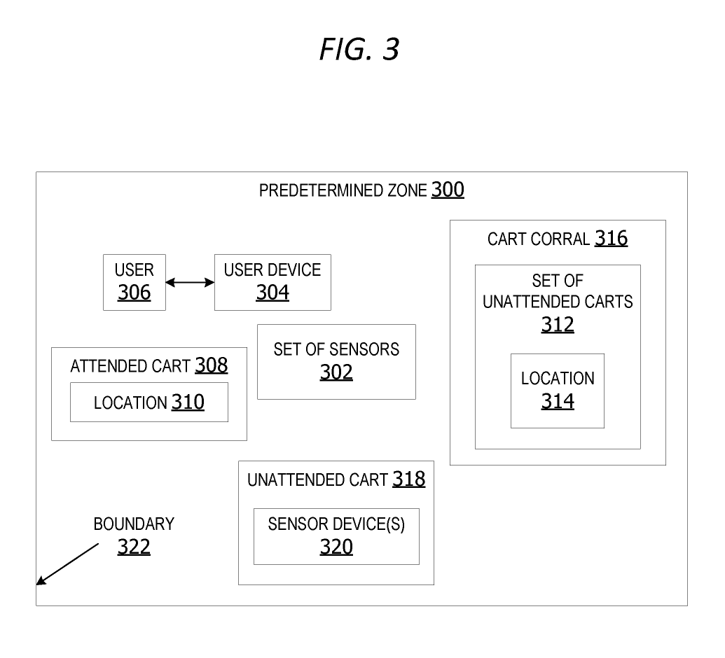

However, in other examples, the predetermined zone in which carts are monitored may include the cart intake area, as is shown in FIG. 3 below. In these examples, a more fine-grained location of a given cart within the cart intake area may be monitored. For example, the system may determine an exact location of a given cart within a cart corral, a row of carts, or other location inside the cart intake area.

The cart intake area 200 in some examples is located inside a retail store, near an entrance or door. This enables entering customers to return carts to the cart intake area immediately upon entrance for greater convenience.

However, the examples are not limited to the cart intake area 200 being located inside a retail store. The cart intake area 200 in one example may be located exterior to a structure, such as an exterior area in proximity to an entrance or adjacent to an entry way into a retail store, or any other suitable area.

The cart intake area 200 may include a set of sensor devices 202 for identifying a cart being returned to the cart intake area 200. The set of sensors may include one or more RFID tag reader(s) 204, one or more barcode reader(s) 206, one or more image capture device 208, one or more microphone(s) 210, as well as any other type of sensor. In some examples, a barcode reader may include a matrix barcode reader, as well as a universal product code (UPC) reader.

The set of sensor devices 202 may include one or more sensors attached to a portion of a structure or fixture within the cart intake area, such as a door, door frame, wall, railing, ramp, gate, roof/ceiling, floor, or any other part of the cart intake area. In other examples, one or more sensor devices may be attached to a cart in a set of returned carts 212.

The set of returned carts 212 may be present within the cart intake area 200. The set of returned carts 212 may include a single cart, two or more carts, as well as a null set of zero carts. The set of returned carts 212 may be located within a cart corral 214 or other structure for securing the returned carts in a stationary position and/or preventing the returned carts from rolling or shifting position while in the cart intake area 200.

A cart 216 in the set of returned carts 212 may include one or more sensor device(s) 218 for identifying the cart, such as a beacon, an RFID tag, a mobile computing device, or any other type of device for automatically identifying a cart. In other examples, one or more sensor device(s) 220 may be attached to a portion of the cart corral 214 for identifying carts as they are placed inside the cart corral 214 by users. For example, an RFID tag reader may be mounted to a side or entryway into the cart corral to read RFID tag data as a cart is pushed inside the cart corral 214.

In some examples, an identification of one or more unattended carts available for return by a user and/or output of a reward is performed by computing device 228. The computing device 228 is a computing device such as, but not limited to, computing device 102 in FIG. 1. The computing device 228 may be implemented as a kiosk, in one illustrative example. The computing device 228 may include an input/output device 222.

The input/output device 222 is a device for receiving user input and outputting data, such as a location of an unattended cart, a feedback query, a reward, or any other data. In some examples, a reward may be printed out in hardcopy form on printer 224. In other examples, the user may provide feedback or review available rewards via the user interface device 226. The user interface device 226 is an interface, such as the user interface component 130 in FIG. 1.

FIG. 3. is an exemplary block diagram illustrating a predetermined cart monitoring zone. In this non-limiting example, a cart monitoring component analyzes sensor data generated by a set of sensors 302 within a predetermined zone 300 to identifying a user 306 and/or a user device 304 associated with the user within the predetermined zone 300. If the user 306 and/or the user device 304 is identified, the system outputs a location 310 of one or more unattended carts within the predetermined zone, such as unattended cart 318. If the user returns the identified unattended cart 318 to a designated cart intake area, the system assigns or outputs a reward to the user 306.

In one example, the user 306 is identified as the user 306 enters a boundary associated with the predetermined zone for monitoring the carts. The user 306 may be detected as the user approaches a cart intake area, approaches a retail location, enters a parking lot, or approaches the cart corral 316. An application running on a personal user device, such as the user device 124 in FIG. 1, detects the user entering the predetermined zone (coming within proximity to the store). In some examples, the user is detected via Wi-Fi signal, geo-location, the application logging-on to a computing system associated with the retail store, etc.

The application running on the user device in this example communicates with the cart monitoring component to obtain the identification/location of one or more unattended carts within proximity to the user 306, such as one or more unattended carts in the parking lot. The cart monitoring component outputs/pushes a location of one or more unattended carts to the user device for display to the user. In this example, the application queries the server for the location of unattended carts and the system outputs the location of unattended cart(s) without the user using a physical kiosk. In another example, the cart monitoring component pushes an unattended cart notification to a mobile device, such as a cell phone, associated with the user via the store application running on the mobile device. The notification identifies any unattended carts available for return in exchange for a reward that are located within proximity to the user and not already being returned by another user.

In another example, the cart monitoring component does not output a location of an unattended cart if the location of the unattended cart has already been output to another user. For example, if two users are located in proximity to unattended cart 318, the cart monitoring component outputs the location of cart 318 to the user that is closest to cart 318. In another example, the cart monitoring component outputs the location of cart 318 to the first user that arrived within proximity of the unattended cart 318 first in time.

The identification and location of cart 318 is only output to a single user. If the first user receiving the notification of the availability of cart 318 for return in exchange for a reward fails to accept and/or rejects the offered return of the cart for a reward, the cart monitoring component then outputs the location of cart 318 to the second user in some examples. In other examples, the cart monitoring component waits a predetermined time after providing an unattended cart notification to the first user. If the first user fails to move the unattended cart 318 within the predetermined time (cart 318 remains stationary in the same location), the cart monitoring component then outputs the location of cart 318 to the second user via a second cart notification sent to a user device associated with the second user. This prevents potential conflicts between multiple users attempting to return the same cart for a reward and/or prevents confusion regarding which user is returning a given cart.

In still another example, if two users are within proximity to a given cart, such as cart 318, and both users have requested a cart return assignment via a kiosk or application running on a user device, the cart monitoring component sends the unattended the system or otherwise requests a cart return, the unattended cart notification for cart 318 is provided to the user that has received the fewest cart return rewards within a predetermined time. This prevents one user from monopolizing cart return rewards at the expense of other users interested in participating in the program that have not yet had an opportunity to earn any cart return rewards.

In this manner, a selected user having the fewest cart return rewards, located closest to a cart, and/or first-in-time to arrive within proximity to the cart is given a right-of-first-refusal regarding return of the cart for a reward.

In some examples, an unattended cart 318 may include one or more sensor device(s) 320 to assist the cart monitoring component in determining a current location of the cart. For example, the sensor device(s) 320 attached to the unattended cart 318 may include a beacon transmitter, an RFID tag, or a GPS transmitter generating sensor data which may be utilized to determine the current location of the unattended cart 318.

In this example, the system outputs a location of a single unattended cart within a given proximity to the user 306. In other words, the system only notifies the user of unattended carts that are near the user 306. In some examples, the system may output unattended carts located within a user-defined radius of the user's current location. If the predetermined radius is ten feet, the system notifies the user of any unattended carts within a ten-foot radius of the user. As the user walks/changes locations, the ten-foot radius around the user changes. The system may optionally add or delete additional unattended carts within the new ten-foot radius as the user moves and the area surrounding the user changes. The user may update the radius to expand or contract the cart search radius surrounding the user's location.

In other examples, the cart management system outputs a location of every unattended cart within the predetermined zone 300 regardless of the user's location. In this example, the system simply identifies any unattended carts which would qualify for a reward if the user returns the cart to the cart intake area.

The unattended carts identified and output to the user in this example are not carts used by the user during shopping. Instead, they are carts that one or more other users abandoned in the parking lot or other area within the predetermined zone.

In still other examples, the cart monitoring component sends a location 314 of a cart corral 316 within the predetermined zone 300 to the user device 304 associated with the user 306 if one or more unattended carts are present within the cart corral 316. In this example, the cart corral 316 includes a set of one or more unattended carts 312. The location 314 of the unattended carts may be output to the user as text directions, a visual map image including an indicator marking the location of one or more unattended carts, and/or audible instructions/directions telling the user 306 where to go to locate the unattended carts.

In another example, the cart monitoring component monitors a location of each cart within the predetermined zone 300 outside the designated cart intake area. In other words, the system monitors the locations of attended carts that are currently in use, as well as the location of unattended carts which have been abandoned. If the cart monitoring component detects a cart crossing a boundary 322 associated with a monitored area. The boundary 322 is a boundary defining the monitored area, including the cart intake area, the retail store, and/or the predetermined zone. If the cart is moved outside this monitored area, the cart monitoring component notifies a cart manager of a potential lost, misappropriated, or misplaced cart which is moving or has already been moved outside the monitoring area. This enables improved ease in locating missing carts and reduces cart losses.

In this example, if a user returns a cart from the identified set of unattended carts to the cart intake area, the user automatically is eligible to receive a reward for the cart return. In other words, the unattended carts and unattended cart locations which are identified by the cart monitoring component and output to the user device are carts which are pre-qualified to receive a cart reward in this non-limiting example. In other examples, if the user returns a cart which was not included in the set of unattended carts output to the user via a user device, kiosk, or other output device, the cart return is not automatically eligible. If the user returns a cart that was excluded from the output set of unattended carts, the verification component analyzes cart intake data associated with the returned cart using a set of reward criteria, such as the reward criteria 134 in FIG. 1, to determine whether to assign a reward to the user for the cart return.

In one example, the set of reward criteria may include a minimum cart return threshold, which is used to determine whether an amount of time between the cart return time when the user returned the cart and a previous cart return time exceeds the minimum cart return threshold. The previous cart return time is the last time the cart was returned to the cart intake area prior to the current user returning the cart to the cart intake area.

In an example, if a given user returns a cart “A” identified in the set of unattended carts, the user automatically receives a cart reward. If the given user returns a cart “B” which was not included in the set of unattended carts provided to the given user at 11:45 a.m., the cart management system identifies the last two times the cart “B” was returned. One of the last two times the cart “B” was returned is the 11:45 a.m. time when the given user returned the cart “B”. The second time is the last return time of the cart “B” prior to 11:45 a.m. If the second return time is 11:05 a.m., then the amount of time between the last two times the cart “B” was returned is forty minutes. If the threshold minimum cart return time is ten minutes, the given user receives a reward.

In the example above, if the second cart return time is 11:41 a.m., then the time between the current cart return time and the previous cart return time for the cart “B” is only four minutes. In this example, the minimum cart return threshold exceeds the amount of time between the last two cart returns. The given user does not receive a cart reward in this example.

The minimum cart return threshold prevents a user from removing a cart from the cart intake area and immediately returning the same cart to the cart intake area or returning the same cart after only a few minutes for the sake of obtaining another reward. This prevents abuse of the cart management system.

The system is not limited to utilizing a minimum cart return threshold. In other examples, eligibility to receive a reward may be determined using a maximum number of cart returns for a given user within a given time-period, and/or a maximum number of cart returns for a given cart within a given time-period.

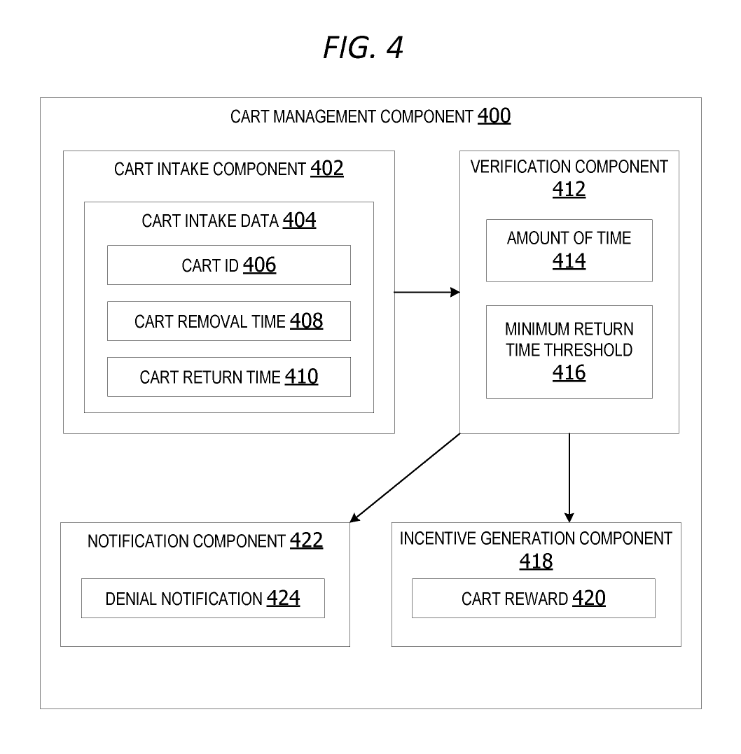

FIG. 4 is an exemplary block diagram illustrating of cart management component. 400. A cart intake component 402 identifies a cart returned to a designated cart intake area by a user based on an analysis of sensor data. The sensor data is generated by at least one sensor device associated with the designated cart intake area, such as the set of sensor devices 118 in FIG. 1 and the set of sensor devices 202 in FIG. 2. The cart intake component 402 generates cart intake data 404 associated with the identified cart.

The cart intake data 404 in some examples includes a cart identifier (ID) 406, a cart removal time 408, and a cart return time 410. The cart ID is a unique identifier for a cart. Each cart in the plurality of carts is given a unique cart ID. The cart removal time 408 is a timestamp indicating a time when a given cart was last removed from the cart intake area. The cart return time 410 is a timestamp indicating a time when a cart is returned to the cart intake area for purposes of determining whether the user is qualified to receive a reward for returning the cart to the cart intake area.

A verification component 412 analyzes the cart intake data 404 to calculate an amount of time 414 between the cart removal time 408 and the cart return time 410. The verification component 412 uses a minimum return time threshold 416 to determine whether the identified user is eligible to receive a cart return reward. The minimum return time threshold 416 prevents user abuse of the incentives system. If the amount of time 414 between the cart removal time 408 and the cart return time 410 is less than the minimum return time threshold 416, the user is ineligible to receive a reward. For example, if the minimum cart return time threshold is ten minutes, this threshold time prevents a user from removing a cart from the cart intake area and then immediately returning the cart back to the cart intake area for the sole purpose of receiving another cart return reward.

If the amount of time between the cart removal time 408 and the cart return time 410 exceeds the minimum return time threshold 416, the user is eligible to receive a reward. An incentive generation component 418 calculates a customized cart reward 420 for the user based on the number of carts returned to the cart intake area. The incentive generation component 418 outputs the calculated cart reward 420 to the identified user for returning the identified cart to the cart intake area on condition the amount of time between the user removing the cart from the cart intake area and returning the cart back to the cart intake area exceeds the minimum return time threshold 416.

If the user is not qualified to receive a reward for returning a cart to the cart intake area, a notification component 422 outputs a rewards denial notification 424 to a computing device associated with the identified user. The computing device may be the user's own personal user device. The computing device may be a device associated with the cart intake area, such as a kiosk.

The denial notification 424 may be sent to the user if the minimum return time threshold 416 exceeds the amount of time between the cart removal time 408 and the cart return time 410 for a given cart. In some examples, the denial notification 424 simply indicates that the user is not qualified to receive a reward for the cart return. In other examples, the denial notification 424 includes a reason for the denial. For example, the denial notification 424 may state that the user is not eligible for a reward because a reward was already provided to the user for returning the same cart within the last ten minutes. In another example, the denial notification may state that the user has already received the maximum rewards for returning the cart on the current day.

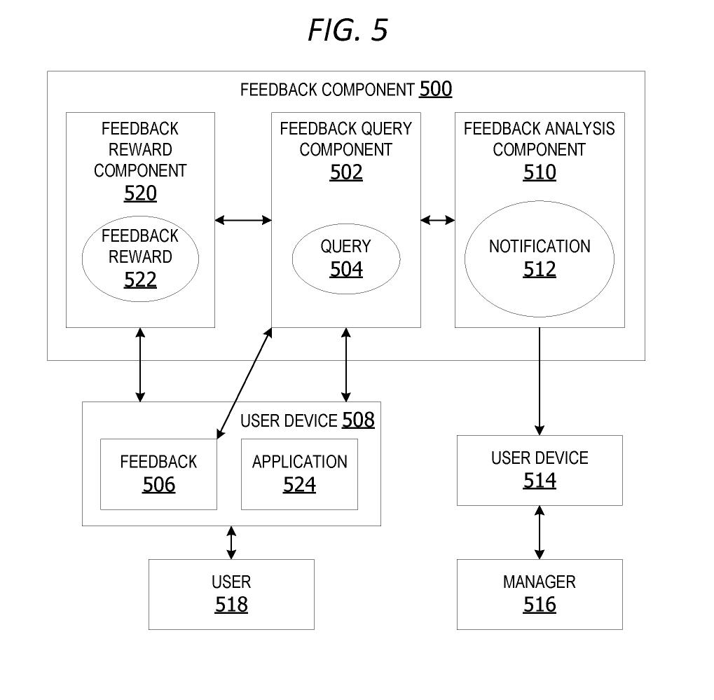

FIG. 5 is an exemplary block diagram illustrating a feedback component 500. In some examples, a feedback query component 502 generates a feedback query 504 and sends the query 504 to a user device 508 associated with a user 518 in response to issuing a reward to the user for returning a cart. The query 504 requests feedback regarding a quality of the cart returned to the cart intake area.

The feedback regarding the cart quality may indicate whether the cart operated as expected/within normal parameters. The feedback in some examples, enables the user to identify any problems associated with the cart that the user returned. For example, the user may provide feedback that identifies a wheel on the cart as wobbly, cracked, balding, locked-up (failing to turn), or failing to pivot. The feedback may provide greater specificity, including an identification of which wheel, such as, but not limited to, the right wheel, the left wheel, front wheel, back wheel, etc.

In some examples, if feedback indicating a mechanical problem is received for a particular cart, the system sends a notification to a manager to remove the cart from service and/or schedule the cart for repair. In other examples, if feedback indicates a mechanical problem or other need for repair, a maintenance or repair flag is added to a record for the cart. The flag indicates that the identified cart should be pulled from service and/or repair or maintenance of the cart is recommended prior to the next scheduled maintenance of the cart.

In other examples, the feedback may indicate cleanliness of the cart. The user may indicate whether the cart is clean or whether the cart is dirty, rusty, sticky, messy, or contains paper/trash or other items that need to be removed/cleaned. If feedback indicates a cart is not clean, the system sends a notification to a manager to remove the cart from service and/or schedule the cart for maintenance. In other examples, a maintenance or repair flag is added to a record for the cart. The flag indicates that the cart should be pulled from service and/or maintenance of the cart is recommended prior to the next scheduled maintenance of the cart.

The feedback query 504 may be implemented as an email or text message sent to a user device, such as a cellular telephone, associated with the user that returned the one or more carts. The user in this non-limiting example selects a link in the email or text message to access a website for providing user feedback.

In other examples, the feedback query 504 is a request sent to an application running on a user device associated with the user that returned the one or more carts. The query 504 triggers the application to download or open a feedback form having fields capable of accepting the user's feedback and/or cart related comments.

In still other examples, the feedback query 504 is a message that appears on a kiosk, user interface, or other input/output device within a field-of-view of the user. The message instructs the user to provide feedback via the kiosk, user interface, or other input/output device to obtain an additional reward.

If feedback 506 is provided by the user 518, a feedback analysis component 510 analyzes the received feedback 506 associated with the cart to determine whether the cart requires maintenance or repair. In some examples, if negative feedback is received indicating a potential maintenance or repair issue associated with the cart, the feedback analysis component assigns a maintenance flag to a cart record in a database associated with the cart identifier of the identified cart. The maintenance flag indicates the identified cart requires repair or maintenance.

In other examples, if negative feedback 506 is received indicating a cart may benefit from maintenance or repair, the feedback analysis component 510 sends a maintenance notification or a repair notification 512 to a user device 514 associated with a manager 516. The manager 516 may be a manager assigned to perform maintenance and/or repair tasks associated with carts. The notification 512 in some examples includes the cart ID and/or an indication of the potential maintenance or repair issue associated with the cart.

A feedback reward component 520, in some examples, outputs a feedback reward 522 to the identified user 518 in response to receiving the feedback 506 associated with the identified cart from the identified user 518. If the user provides feedback associated with multiple carts, the feedback reward component 520 may provide multiple feedback rewards and/or increase the feedback reward 522 commensurate with the amount of feedback provided.

In some examples, the user 518 provides the feedback 506 via a kiosk, a mobile computing device provided to the user at the cart intake area, or other computing device associated with the cart or the cart intake area. In other examples, the user provides the feedback 506 via a link sent to the user device 508 associated with the user 518 in the query 504. In yet other examples, an application 524 is provided to the user for download onto the user device 508. The application 524 permits the user 518 to log-on to a feedback website or otherwise access an on-line feedback form enabling the user to provide cart feedback via the user device 508.

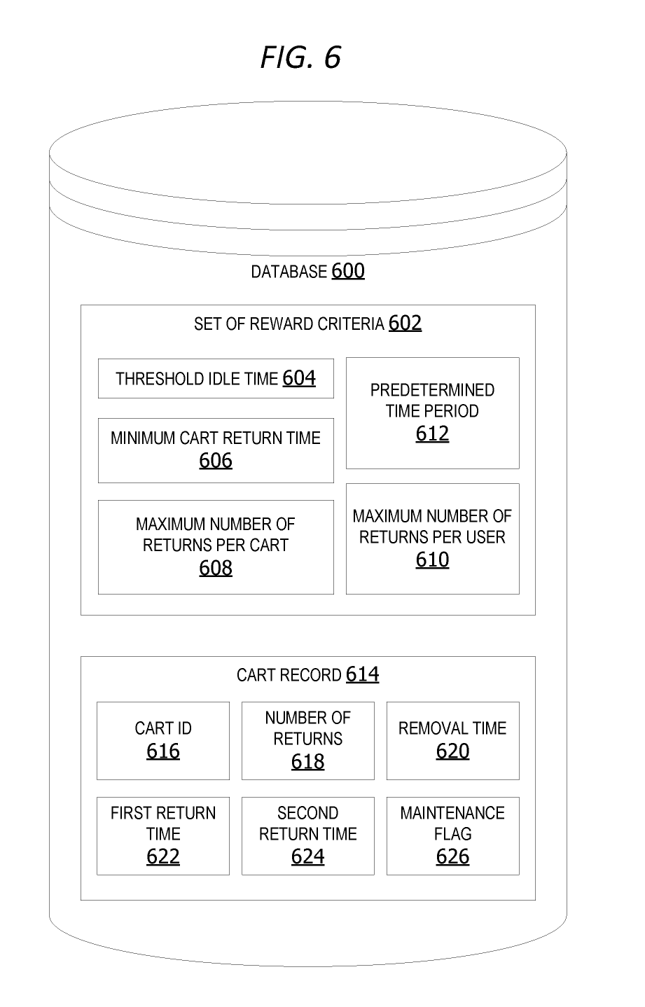

FIG. 6 is an exemplary block diagram illustrating a database storing cart management data. The database 600 may be associated with a data storage device, such as, but not limited to, the data storage device 132 in FIG. 1. The database 600 may include a set of reward criteria 602, such as, but not limited to, the set of one or more reward criteria 134 in FIG. 1.

In this non-limiting example, the set of reward criteria 602 includes a threshold idle time 604, a minimum cart return time 606, a maximum number of returns per-cart 608, a maximum number of returns per-user 610, and/or a predetermined time-period 612.

The threshold idle time 604 is a minimum amount of time that a cart which is no longer moving remains in a same location or a stationary position before the cart is identified as an unattended cart. For example, if the threshold idle time 604 is ten minutes, a cart that is idle for only six minutes before moving again is not identified as an unattended cart. If a cart remains in the same position in a parking area without moving for eleven minutes, the cart is identified as an unattended cart.

In another example, the threshold idle time 604 is only applied to carts that remain idle in a parking area outside a retail store and/or other area outside a cart intake area. In other examples, the threshold idle time 604 is not applicable to carts left in a cart corral outside a cart intake area. A cart corral is any designated area outside the cart intake area where a cart may be left. A cart corral may include rails, bars, or stops to prevent carts from rolling away.

In other words, if a cart is returned to a cart corral in a parking lot, the cart is automatically designated as an unattended cart without application of the threshold idle time 604. For example, when a cart is detected as it is being pushed into a cart corral, the detected cart is automatically identified as an unattended cart.

A cart may be detected entering a cart corral or other holding area outside a cart intake area, based on sensor data received from one or more sensors attached to the cart corral. The one or more sensor devices for reading a cart identifier on the cart. The one or more sensor devices may include an RFID tag reader for reading cart identification data from an RFID tag attached to the cart. In other examples, the one or more sensors may include a scanner associated with the cart corral for reading cart identification data from a barcode on the cart.

The minimum cart return time 606 is a minimum amount of time between the time when a cart is removed from a cart intake area by an identified user and the time when the identified user returns the cart to a cart intake area when a user may receive a reward for the cart return. In some examples, the cart is removed from a first cart return area and returned to the same first cart return area. In other examples, the cart is removed from a first cart return area and the cart is returned to a second cart return area that is different than the first cart return area.

In other examples, the minimum cart return time 606 is a minimum amount of time between a first cart return time and a second cart return time. The first cart return time is the time when the identified user returns an identified cart to a cart intake area for a reward. The second cart return time is a previous time when the cart was returned to the cart intake area. For example, if a first user returns the cart to the cart intake area at 1:00 p.m. and a second user returns the cart to the cart intake area at 1:30 p.m., the amount of time between the first cart return time and the second cart return time is thirty minutes. If the minimum cart return time 606 is fifteen minutes, the first user receives a reward for returning the cart at 1:30 p.m. because the amount of time between the last two cart return times is greater than the minimum amount of time 606, in this example.

The maximum number of returns per-cart 608 is a maximum number of times an identified cart may returned to a cart intake area for a reward within a predetermined time-period 612. When a cart has been returned the maximum number of times, rewards are no longer issued for return of the identified cart until expiration of the predetermined time-period. For example, if the maximum number of returns per-cart is 2 returns per each twelve-minute time-period, the cart management system outputs a reward for two cart returns during the twelve-minute time-period. If a first user returns the cart at 3:05 p.m. and a second user returns the same cart at 3:13 p.m., the cart management system will not provide a reward to any user that returns the same cart at 3:15 p.m. because the maximum number of cart returns for that cart within a twelve-minute time-period has already been exceeded.

Thus, in some examples, the incentives generation component outputs a cart return reward to a user as a reward for returning the identified cart to the cart intake area on condition the threshold maximum number of cart returns for the identified cart exceeds a number of cart returns for the identified cart that have occurred within the predetermined time-period 612. The notification component outputs a rewards denial notification to the user if the number of cart returns for the identified cart within the predetermined time-period exceeds the threshold maximum number of cart returns for the identified cart. In some examples, the reward denial notification includes a reason for denial, such as a maximum cart returns exceeded message.

A maximum number of returns per-user 610 is a maximum number of carts that an identified user is permitted to return for a reward. If the number of carts returned by the user within a predetermined time-period exceeds the maximum number of returns for the identified user, the cart management system will cease providing rewards until the predetermined time-period expires. For example, if the maximum number of returns per-user 610 is fifteen carts within a twenty-four-hour time-period, the cart management system will not output a reward to the identified user if the user for return of a sixteenth cart.

Thus, in some examples, the incentives generation component outputs a cart return reward to an identified user for returning a cart to the cart intake area if the threshold maximum number of cart returns for the user within a given time-period exceeds the number of carts returned by the identified user during that time-period. The notification component in other examples, outputs a rewards denial notification to a user device or user interface associated with the user if the number of carts returned by the identified user within the predetermined time-period exceeds the threshold maximum number of cart returns.

The database 600 may optionally include a cart record 614 for one or more carts. The cart record 614 may include a cart ID 616, a number of returns 618 within a given time-period, a last removal time 620 from the cart intake area, a first return time 622 associated with a previous removal of the cart from the cart intake area, and a second return time 624 associated with the last time the cart was removed from the cart intake area.

The cart ID 616 is a unique identifier for a particular cart. The cart ID 616 may include a serial number for a cart, a UPC code, or any other unique identification for a cart.

The cart record 614 may also optionally include a maintenance flag 626 indicating the cart is due for maintenance or repair. An absence of a maintenance flag indicates the cart is not due for maintenance or repair.

FIG. 7 is an exemplary flow chart illustrating operation of the computing device to provide a cart reward based on a threshold minimum cart return time. The process shown in FIG. 10 may be performed by a cart management component executing on a computing device, such as, but not limited to, the computing device 102 in FIG. 1.

The process begins by analyzing sensor data, such as the sensor data to identify one or more cart(s) returned to a cart intake area at 702. The sensor data may include data such as sensor data 136 in FIG. 1 received from the set of sensor devices 118 in FIG. 1. The sensor data is analyzed by a cart intake component, such as cart intake component 402 in FIG. 4.

A determination is made whether a cart is returned at 704. If no, the process determines whether to continue at 706. If no, the process terminates thereafter. If the process continues at 706, operations 702 through 706 are iteratively executed until a cart is returned at 704. The returned cart may be a shopping cart, such as, but not limited to, a cart in the plurality of carts 120 in FIG. 1, cart 216 in FIG. 2, or unattended cart 318 in FIG. 3.

Cart intake data associated with the returned cart is generated at 708. The cart intake data includes data such as, but not limited to, cart intake data 404 in FIG. 4. An amount of time between cart removal and cart return is calculated at 710 based on the cart intake data. In some examples, the amount of time may be calculated by verification component 412 in FIG. 4.

A determination is made, by the verification component, whether the amount of time between the cart removal and cart return exceeds a minimum time at 712. In some examples, the minimum time is a threshold such as, but not limited to, the minimum cart return time 606 in FIG. 6. If the amount of time exceeds the minimum time at 712, an incentive generation component 418 in FIG. 4 outputs a cart reward at 714. The process terminates thereafter.

Returning to 712, if the amount of time does not exceed the minimum time, the notification component 422 in FIG. 4 outputs a denial notification 716 to the user. The denial notification may be output to the user via a user interface component 130 in FIG. 1 or via a user device associated with the user, such as the user device 124 in FIG. 1, the user device 304 in FIG. 3, or the user device 508 in FIG. 5.

While the operations illustrated in FIG. 7 are performed by a server or other computing device, aspects of the disclosure contemplate performance of the operations by other entities. For example, a cloud service may perform one or more of the operations.

FIG. 8 is an exemplary flow chart illustrating operation of the computing device to assign rewards to a user based on carts returned by the user and cart feedback received from the user. The process shown in FIG. 10 may be performed by a cart management component executing on a computing device, such as, but not limited to, the computing device 102 in FIG. 1.

The process begins by calculating an amount of time between a first cart return time and a second cart return time at 802. The amount of time may be calculated by the verification component 412 in FIG. 4. A determination is made by the verification component whether the amount of time exceeds a minimum threshold time at 804. If no, the process terminates thereafter.

Returning to 804, if the amount of time between a first and second return time exceeds a minimum threshold time, the incentive generation component 418 in FIG. 4 assigns a first reward to the user at 806. A feedback query component 502 in FIG. 5 determines if feedback is received at 808. If no, the process terminates thereafter.

Returning to 808, if feedback is received, the feedback reward component 520 in FIG. 5 assigns a second reward to the user at 810. The process terminates thereafter.

While the operations illustrated in FIG. 8 are performed by a server or other computing device, aspects of the disclosure contemplate performance of the operations by other entities. For example, a cloud service may perform one or more of the operations.

FIG. 9 is an exemplary flow chart illustrating operation of the computing device to output a cart reward based on a number of cart returns. The process shown in FIG. 10 may be performed by a cart management component executing on a computing device, such as, but not limited to, the computing device 102 in FIG. 1.

The process begins by a cart intake component 402 in FIG. 2 identifying a cart returned by a user at 902. The verification component 412 in FIG. 4 retrieves a number of returns for the identified cart within a predetermined time-period at 904. The verification component determines whether the number of returns is less than a per-cart threshold at 906. The per-cart threshold is a maximum number of cart returns for a cart within a predetermined time-period. If no, the notification component 422 in FIG. 4 outputs a denial notification 908. The process terminates thereafter.

Returning to 906, if the number of returns is less than the per-cart threshold, the verification component retrieves a number of cart returns by the user within the predetermined time-period at 910. The number of cart returns by the user may be retrieved from a data store, such as the data storage device 132 in FIG. 1 or the database 600 in FIG. 6. If no, the notification component outputs the denial notification at 908. The process terminates thereafter.

Returning to 912, if the number of returns by the user is less than the per-user maximum threshold, the incentive generation component outputs a reward to the user at 914. The process terminates thereafter.

While the operations illustrated in FIG. 9 are performed by a server or other computing device, aspects of the disclosure contemplate performance of the operations by other entities. For example, a cloud service may perform one or more of the operations.

FIG. 10 is an exemplary flow chart illustrating operation of the computing device to output rewards to a user for returning unattended carts in a predetermined zone. The process shown in FIG. 10 may be performed by a cart management component executing on a computing device, such as, but not limited to, the computing device 102 in FIG. 1.

The process begins by the cart monitoring component 114 in FIG. 1 analyzing sensor data associated with a predetermined zone 1002. The cart monitoring component determines whether a user device is detected within the predetermined zone at 1004. If no, the process returns to 1002 and iteratively executes 1002 through 1004 until a user device is detected.

When a user device is detected within the predetermined zone, the cart monitoring component determines whether there are any unattended carts within the predetermined zone at 1006. If no, the process terminates thereafter.

If at least one unattended cart is present in the predetermined zone, the cart monitoring component outputs the location of the unattended cart(s) within the zone at 1008. The cart intake component determines if an unattended cart is returned at 1010. If no, the process terminates thereafter.

If one or more unattended carts are returned to the cart intake area by the user at 1010, the incentive generation component outputs a reward to the user device at 1012. The process terminates thereafter.

While the operations illustrated in FIG. 10 are performed by a server or other computing device, aspects of the disclosure contemplate performance of the operations by other entities. For example, a cloud service may perform one or more of the operations.

FIG. 11 is an exemplary flow chart illustrating operation of the computing device to identify unattended carts. The process shown in FIG. 10 may be performed by a cart monitoring component executing on a computing device, such as, but not limited to, the computing device 102 in FIG. 1.

The process begins by a cart monitoring component determining if a cart is detected outside a cart intake area at 1102. If no, the process terminates thereafter. If a cart is detected outside the cart intake area, the cart monitoring component determines if the detected cart is stationary for a threshold idle time at 1104. If no, the cart monitoring component continues monitoring the cart at 1106.

When the cart is stationary for the threshold idle time at 1104, the cart monitoring component identifies the cart as an unattended cart at 1108. The process terminates thereafter.

While the operations illustrated in FIG. 11 are performed by a server or other computing device, aspects of the disclosure contemplate performance of the operations by other entities. For example, a cloud service may perform one or more of the operations.

FIG. 12 is an exemplary flow chart illustrating operation of the computing device to manage cart feedback received from a user. The process shown in FIG. 10 may be performed by a feedback component executing on a computing device, such as, but not limited to, the computing device 102 in FIG. 1.

The process begins by the feedback query component sending a feedback request to a user device associated with an identified user that returned a cart at 1202. The feedback query component determines if feedback is received at 1204. If no, the process terminates thereafter.

If feedback is received at 1204, the feedback reward component 520 in FIG. 5 outputs a feedback reward to the identified user at 1206. The feedback analysis component 510 analyzes the feedback at 1208. The feedback analysis component determines if repair or maintenance of the cart is indicated based on the feedback at 1212. If no, the process terminates thereafter.

If maintenance or repair is indicated at 1212, the feedback analysis component assigns a maintenance flag to a cart ID in a database at 1214. The database may be any type of data store, such as the database 600 in FIG. 6. The maintenance flag indicates repair or maintenance is due to be performed on the identified cart. The process terminates thereafter.

While the operations illustrated in FIG. 12 are performed by a server or other computing device, aspects of the disclosure contemplate performance of the operations by other entities. For example, a cloud service may perform one or more of the operations.

### Additional Examples

In some examples, the cart management system monitors shopping carts in a store environment. The system identifies the customer via an application on a portable device, such as a mobile phone or tablet device. The system tracks a location of each shopping cart using sensors, such as a reader on a door to identify a given cart that is taken out and brought back in. The system provides incentives to the shopper for returning the cart.

In an example, the cart management system identifies a customer that returns a shopping cart to a cart intake area via a mobile device application. The system identifies the shopping cart using sensors, such as RFID tags. The system provides incentives to the customer for each shopping cart returned to the cart intake area.

In another example, the cart monitoring component tracks movements of carts outside a store environment. If a cart is taken outside a boundary of a parking lot or other exterior area monitored by the system, the cart monitoring component alerts one or more managers regarding the lost or potentially stolen cart which is no longer located within an acceptable zone associated with the retail environment.

In yet another example, image data from a camera mounted on or near a door or cart intake area captures images of carts being removed and returned to the cart intake area and/or carts being removed or returned to the store via the door. If image data indicates that a cart is removed from the store or the cart intake area and immediately returned, the user does not receive a reward.

In another example, a user may sign-up or register to participate in the cart rewards and feedback rewards program. The user signs-up, creates an account/log-in, signs waiver(s), and/or downloads an application for receiving rewards and providing feedback via the application.

In some examples, when a cart is returned, sensor devices automatically register the identification of the returned cart. In other examples, the user returning the cart utilizes a hand scanner device to manually scan a barcode or other identification tag on the returned cart to register return of the cart and obtain a reward.

The user in other examples logs-on at a kiosk to provide cart feedback and receive a feedback reward. In this example, the user may provide a user name, password, or other login data to access a cart reward account. While accessing the account, the user is provided with the opportunity to give feedback regarding one or more carts recently returned to the cart intake area. If the user provides the feedback at the kiosk, the user is issued a feedback reward.

Rewards for cart returns and/or providing feedback may be issued via a printout at a kiosk or stand-alone printer device associated with the cart intake area. In this example, when the system identifies a cart return that is eligible for a reward, the kiosk or printer prints out a coupon or other reward for the user. In this example, identification of a user and/or creation of a user account is unnecessary, as the reward is printed. This provides greater ease with which to dispense rewards for users which choose not to logon/signup or download the cart return application.

In still other examples, the cart management system identifies a route through a retail store on which a shopping cart is taken by a user. The route indicates where the user pushes the cart during shopping. The route may be used to determine whether to provide a reward in some examples. For example, if the route of a particular cart indicates the cart was only taken out of the cart intake area and pushed to a water fountain and then brought back to the cart intake area, the verification component disqualifies the user from receiving a reward because the cart utilization was not a shopping use. This prevents abuse of the cart reward system.

In another example, if the route taken by a particular cart moves around a circumference of a retail store, is moved to a POS area, and then is returned to the cart intake area, the verification component verifies that the utilization of the cart was for a shopping transaction and the cart reward is provided. The route data in other examples may also be utilized to determine how customers navigate through stores.

Alternatively, or in addition to the other examples described herein, examples include any combination of the following:
a feedback query component that queries the user device associated with the identified user for feedback regarding a quality of the identified cart returned to the cart intake area;
a feedback analysis component that analyzes feedback associated with the identified cart received from at least one user to determine whether the identified cart requires maintenance or repair;
assigning a maintenance flag, in a database, to the cart identifier of the identified cart in response to a determination that the identified cart requires maintenance or repair;
a feedback reward component, implemented on the at least one processor, that outputs a feedback reward to the identified user in response to receiving feedback associated with the identified cart from the identified user;
a cart monitoring component, implemented on the at least one processor, that outputs a location of each cart in a set of unattended carts within a predetermined zone outside a designated cart intake area in response to identifying the user device associated with the identified user within the predetermined zone;
an unattended cart identified as a cart remaining in a stationary position outside the designated cart intake area for a threshold idle time;
wherein the identified user receives a reward for each cart in the set of unattended carts returned to the cart intake area;
a cart monitoring component that monitors a location of each cart within a predetermined zone outside a designated cart intake area;
wherein the cart monitoring component notifies a cart manager in response to identifying a cart leaving a boundary associated with the predetermined zone;
wherein the incentives generation component outputs the cart return reward to the identified user for returning the identified cart to the cart intake area on condition the threshold maximum number of cart returns per identified cart exceeds a number of cart returns for the identified cart within a predetermined time-period;
wherein the notification component outputs a rewards denial notification to the identified user on condition the number of cart returns for the identified cart within a predetermined time-period exceeds the threshold maximum number of cart returns per identified cart;
wherein the incentives generation component outputs the cart return reward to the identified user for returning the identified cart to the cart intake area on condition the threshold maximum number of cart returns per user exceeds a number of carts returned by the identified user within a predetermined time-period;
wherein the notification component outputs a rewards denial notification to the computing device on condition the number of carts returned by the identified user within a predetermined time-period exceeds the threshold maximum number of cart returns per identified cart;
on condition of identifying another cart in the one or more returned carts excluded from the output set of unattended carts, analyzing cart intake data associated with the other identified cart using a set of reward criteria to determine whether to assign a reward to the identified user for returning the other identified cart, the set of reward criteria comprising a minimum cart return threshold;
wherein a reward for returning the other identified cart is provided to the identified user if a time-period between the first cart return time and a second cart return time for the other identified cart exceeds the minimum cart return threshold, the second cart return time comprising a time associated with a previous return of the identified cart to the cart intake area;
on condition of identifying another cart in the set of returned carts excluded from the output set of unattended carts, analyzing cart intake data associated with the other identified cart using a set of reward criteria to determine whether to assign a reward to the user for returning the other identified cart;
the set of reward criteria comprising a maximum number of returns per cart, wherein a reward for returning the other identified cart is provided to the identified user if a number of cart returns for the other identified cart within a predetermined time-period is less than the maximum number of returns per cart;
on condition of identifying another cart in the set of returned carts excluded from the output set of unattended carts, analyzing cart intake data associated with the other identified cart using a set of reward criteria to determine whether to assign a reward to the identified user for returning the other identified cart;
the set of reward criteria comprising a maximum number of cart returns per user;
wherein a reward for returning the other identified cart is provided to the identified user if a number of cart returns by the identified user within a predetermined time-period is less than the maximum number of cart returns per user;
analyzing sensor data generated by a set of sensors associated with the predetermined zone to monitor movement of an identified cart within the predetermined zone, by the cart monitoring component;
wherein the cart monitoring component sends a notification to a user device associated with a cart manager in response to the identified cart moving outside the predetermined zone;
analyzing feedback associated with the identified cart, wherein the feedback analysis component outputs a maintenance notification to a cart manager in response to the feedback;
analyzing feedback associated with the identified cart;
wherein the feedback analysis component outputs a repair notification to a cart manager in response to the feedback;
flagging a cart identifier of the identified cart for maintenance or repair in response to receiving negative feedback associated with the identified cart from at least one user;
outputting a notification of ineligibility for the cart return reward in response to a determination that the amount of time between the first cart return time and the second cart return time is less than the minimum return threshold time;
outputting a feedback reward to the user device associated with the identified user in response to receiving feedback associated with the identified cart from the identified user;
flagging the cart identifier of the identified cart for maintenance or repair in response to receiving negative feedback associated with the identified cart from at least one user.

At least a portion of the functionality of the various elements in FIG. 1, FIG. 2, FIG. 3, FIG. 4, FIG. 5, and FIG. 6 may be performed by other elements in FIG. 1, FIG. 2, FIG. 3, FIG. 4, FIG. 5, and FIG. 6 or an entity (e.g., processor, web service, server, application program, computing device, etc.) not shown in FIG. 1, FIG. 2, FIG. 3, FIG. 4, FIG. 5, and FIG. 6.

In some examples, the operations illustrated in FIG. 7, FIG. 8, FIG. 9, FIG. 10, FIG. 11, and FIG. 12 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for customized cart management. For example, the elements illustrated in FIG. 1, FIG. 2, FIG. 3, FIG. 4, FIG. 5, and FIG. 6, such as when encoded to perform the operations illustrated in FIG. 7, FIG. 8, FIG. 9, FIG. 10, FIG. 11, and FIG. 12, constitute exemplary means for identifying a cart returned to a designated cart intake area by an identified user based on analyzed sensor data generated by at least one sensor device associated with the designated cart intake area and generates cart intake data associated with the identified cart; exemplary means for analyzing the cart intake data using a minimum return time threshold to determine whether the identified user is eligible to receive a cart return reward; exemplary means for outputting the cart return reward to the identified user for returning the identified cart to the cart intake area on condition an amount of time between the cart removal time and the cart return time for the identified cart exceeds the minimum return time threshold; exemplary means for outputting a rewards denial notification to a computing device associated with the identified user on condition the minimum return time threshold exceeds the amount of time between the cart removal time and the cart return time for the identified cart.

In another example, the elements illustrated in FIG. 1, FIG. 2, FIG. 3, FIG. 4, FIG. 5, and FIG. 6, such as when encoded to perform the operations illustrated in FIG. 7, FIG. 8, FIG. 9, FIG. 10, FIG. 11, and FIG. 12, constitute exemplary means for outputting a location of each cart in a set of unattended carts within a predetermined zone outside a designated cart intake area to a user device associated with an identified user in response to identifying the user device within the predetermined zone; exemplary means for identifying one or more carts returned to the designated cart intake area by the identified user based on analyzed sensor data generated by at least one sensor device associated with the designated intake area; exemplary means for assigning a first reward to the identified user for each cart in the one or more returned carts that corresponds to the set of unattended carts; exemplary means for outputting a feedback query associated with at least one cart in the one or more returned carts to the identified user via the user device; and exemplary means for assigning a second reward to the identified user on condition of receiving feedback in response to the feedback query.

In still another example, the elements illustrated in FIG. 1, FIG. 2, FIG. 3, FIG. 4, FIG. 5, and FIG. 6, such as when encoded to perform the operations illustrated in FIG. 7, FIG. 8, FIG. 9, FIG. 10, FIG. 11, and FIG. 12, constitute exemplary means for analyzing sensor data received from at least one sensor associated with a cart intake area to identify a cart returned to the cart intake area by at least one user; exemplary means for generating cart intake data associated with the identified cart, the cart intake data comprising a cart identifier and a first cart return time; exemplary means for verifying the at least one user as an identified user eligible to receive a cart return reward based on the first cart return time and a second cart return time; and assigning a cart return reward to the identified user for returning the identified cart to the cart intake area on condition an amount of time between the first cart return time and the second cart return time for the identified cart exceeds a minimum cart return threshold time.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for customized cart management, the system comprising:
a memory;
at least one processor communicatively coupled to the memory;
a cart intake component, implemented on the at least one processor, that identifies a cart returned to a designated cart intake area by an identified user based on analyzed sensor data generated by at least one sensor device associated with the designated cart intake area and generates cart intake data associated with the identified cart, the cart intake data comprising a cart identifier, a cart removal time, and a cart return time;
a verification component, implemented on the at least one processor, that analyzes the cart intake data using a minimum return time threshold to determine whether the identified user is eligible to receive a cart return reward;
an incentives generation component, implemented on the at least one processor, that outputs the cart return reward to the identified user for returning the identified cart to the cart intake area on condition an amount of time between the cart removal time and the cart return time for the identified cart exceeds the minimum return time threshold;
a notification component, implemented on the at least one processor, that outputs a rewards denial notification to a computing device associated with the identified user on condition the minimum return time threshold exceeds the amount of time between the cart removal time and the cart return time for the identified cart.

2. The system of claim 1, further comprising:
a feedback query component, implemented on the at least one processor, that queries a user device associated with the identified user for feedback regarding a quality of the identified cart returned to the cart intake area.

3. The system of claim 1, further comprising:
a feedback analysis component, implemented on the at least one processor, that analyzes feedback associated with the identified cart received from at least one user to determine whether the identified cart requires maintenance or repair, and assigns a maintenance flag, in a database, to the cart identifier of the identified cart in response to a determination that the identified cart requires maintenance or repair.

4. The system of claim 1, further comprising:
a feedback reward component, implemented on the at least one processor, that outputs a feedback reward to the identified user in response to receiving feedback associated with the identified cart from the identified user.

5. The system of claim 1, further comprising:
a cart monitoring component, implemented on the at least one processor, that outputs a location of each cart in a set of unattended carts within a predetermined zone outside the designated cart intake area in response to identifying a user device associated with the identified user within the predetermined zone, an unattended cart identified as a cart remaining in a stationary position outside the designated cart intake area for a threshold idle time, wherein the identified user receives a reward for each cart in the set of unattended carts returned to the cart intake area.

6. The system of claim 1, further comprising:
a cart monitoring component, implemented on the at least one processor, that monitors a location of each cart within a predetermined zone outside the designated cart intake area, wherein the cart monitoring component notifies a cart manager in response to identifying a cart leaving a boundary associated with the predetermined zone.

7. The system of claim 1, further comprising:
a threshold maximum number of cart returns per identified cart, wherein the incentives generation component outputs the cart return reward to the identified user for returning the identified cart to the cart intake area on condition the threshold maximum number of cart returns per identified cart exceeds a number of cart returns for the identified cart within a predetermined time-period, and wherein the notification component outputs the rewards denial notification to the identified user on condition the number of cart returns for the identified cart within the predetermined time-period exceeds the threshold maximum number of cart returns per identified cart.

8. The system of claim 1, further comprising:
a threshold maximum number of cart returns per identified user, wherein the incentives generation component outputs the cart return reward to the identified user for returning the identified cart to the cart intake area on condition the threshold maximum number of cart returns per user exceeds a number of carts returned by the identified user within a predetermined time-period, and wherein the notification component outputs the rewards denial notification to the computing device on condition the number of carts returned by the identified user within the predetermined time-period exceeds the threshold maximum number of cart returns per identified user.

9. A computer-implemented method for customized cart management, the computer-implemented method comprising:
outputting, by a cart monitoring component, a location of each cart in a set of unattended carts within a predetermined zone outside a designated cart intake area to a user device associated with an identified user in response to identifying the user device within the predetermined zone, an unattended cart identified as a cart remaining in a stationary position outside the designated cart intake area for a threshold idle time;
identifying, by a cart intake component, one or more carts returned to the designated cart intake area by the identified user based on analyzed sensor data generated by at least one sensor device associated with the designated intake area;
assigning, by an incentives generation component, a first reward to the identified user for each cart in the one or more returned carts that corresponds to the set of unattended carts;
outputting, by a feedback query component, a feedback query associated with at least one cart in the one or more returned carts to the identified user via the user device; and
assigning, by a feedback reward component, a second reward to the identified user on condition of receiving feedback in response to the feedback query.

10. The computer-implemented method of claim 9, further comprising:
on condition of identifying a first cart in the one or more returned carts excluded from the set of unattended carts, analyzing cart intake data associated with the first cart using a set of reward criteria to determine whether to assign a reward to the identified user for returning the first cart, the set of reward criteria comprising a minimum cart return threshold, wherein the reward for returning the first cart is provided to the identified user if a time-period between the first cart return time and a second cart return time for the first cart exceeds the minimum cart return threshold, the second cart return time comprising a time associated with a previous return of the first cart to the cart intake area.

11. The computer-implemented method of claim 9, further comprising:
on condition of identifying a first cart in a set of returned carts excluded from the set of unattended carts, analyzing cart intake data associated with the first cart using a set of reward criteria to determine whether to assign a reward to the identified user for returning the first cart, the set of reward criteria comprising a maximum number of returns per cart, wherein the reward for returning the first cart is provided to the identified user if a number of cart returns for the first cart within a predetermined time-period is less than the maximum number of returns per cart.

12. The computer-implemented method of claim 9, further comprising:
on condition of identifying a first cart in a set of returned carts excluded from the set of unattended carts, analyzing cart intake data associated with the first cart using a set of reward criteria to determine whether to assign a reward to the identified user for returning the first cart, the set of reward criteria comprising a maximum number of cart returns per user, wherein the reward for returning the first cart is provided to the identified user if a number of cart returns by the identified user within a predetermined time-period is less than the maximum number of cart returns per user.

13. The computer-implemented method of claim 9, further comprising:
analyzing sensor data generated by a set of sensors associated with the predetermined zone to monitor movement of an identified cart within the predetermined zone, by the cart monitoring component, wherein the cart monitoring component sends a notification to a user device associated with a cart manager in response to the identified cart moving outside the predetermined zone.

14. The computer-implemented method of claim 9, further comprising:
analyzing, by a feedback analysis component, feedback associated with an identified cart, wherein the feedback analysis component outputs a maintenance notification to a cart manager in response to the feedback.

15. The computer-implemented method of claim 9, further comprising:
analyzing, by a feedback analysis component, feedback associated with an identified cart, wherein the feedback analysis component outputs a repair notification to a cart manager in response to the feedback.

16. The computer-implemented method of claim 9, further comprising:
flagging a cart identifier of an f for maintenance or repair in response to receiving negative feedback associated with the identified cart from at least one user.

17. One or more computer storage media, having computer-executable instructions for customized cart management that, when executed by a computer cause the computer to perform operations comprising:
analyzing sensor data received from at least one sensor associated with a cart intake area to identify a cart returned to the cart intake area by at least one user;
generating cart intake data associated with the identified cart, the cart intake data comprising a cart identifier and a first cart return time; verifying the at least one user as an identified user eligible to receive a cart return reward based on the first cart return time and a second cart return time, the second cart return time comprising a time associated with a previous return of the identified cart to the cart intake area; and
assigning the cart return reward to the identified user for returning the identified cart to the cart intake area on condition an amount of time between the first cart return time and the second cart return time for the identified cart exceeds a minimum cart return threshold time.

18. The one or more computer storage media of claim 17, wherein the computer-executable instructions for customized cart management further comprises:
outputting a notification of ineligibility for the cart return reward in response to a determination that the amount of time between the first cart return time and the second cart return time is less than the minimum return threshold time.

19. The one or more computer storage media of claim 17, wherein the computer-executable instructions for customized cart management further comprises:
outputting a feedback reward to a user device associated with the identified user in response to receiving feedback associated with the identified cart from the identified user.

20. The one or more computer storage media of claim 17, wherein the computer-executable instructions for customized cart management further comprises:
flagging the cart identifier of the identified cart for maintenance or repair in response to receiving negative feedback associated with the identified cart from the at least one user.
